(19) United States
(12) Patent Application Publication
(10) Pub. No.: US 2012/0101955 A1
(43) Pub. Date: Apr. 26, 2012

(54) TOKEN-BASED METHOD FOR FACILITATING EMPLOYMENT OVER A COMMUNICATIONS NETWORK

(75) Inventors: Matthew T. Mosher, Lake Orion, MI (US); Doyle W. Mosher, Birmingham, MI (US); Erinn J. O'Connor, Lake Orion, MI (US)

(73) Assignee: HIREDMYWAY, Birmingham, MI (US)

(21) Appl. No.: 13/278,232

(22) Filed: Oct. 21, 2011

Related U.S. Application Data
(60) Provisional application No. 61/405,689, filed on Oct. 22, 2010.

(51) Int. Cl. G06Q 10/06; G06Q 30/00

(52) U.S. Cl. 705/321

(57) ABSTRACT

Token-based method of facilitating employment over a communications network is provided. The method includes providing at least one database of electronic data at a computer site. The data includes cost data that identifies a cost to a job applicant to apply for each job associated with job opportunities and for which payment in tokens is required. The method further includes transferring at least one token from a token account of the job applicant to a token escrow account in response to a job application signal. A monetary or associated currency value of the at least one token is based on the cost to apply for the desired job. The method further includes debiting the at least one token identified with a job applicant applying for a desired job from the token escrow account when job applicant data is received and viewed by the job provider associated with the desired job.

### CROSS-REFERENCE TO RELATED APPLICATIONS

This application claims the benefit of U.S. provisional patent application Ser. No. 61/405,689 filed on Oct. 22, 2010 and entitled “Computerized Method and System for Employment Recruitment.”

### BACKGROUND

### Technical Field

The present invention generally relates to methods for facilitating employment placement/recruitment over a communications network.

### Overview

For many years, online job boards have provided a means for a job seeker and a recruiter or employer to connect. However, job boards such as Monster.com, CareerBuilder.com, Simply Hired, and Hot Jobs require a recruiter or employer to pay to post a job position with no guarantee of finding the right candidate for the job position. For each position posted, the recruiter/employer may be inundated with resumes. Oftentimes, the candidates are unqualified for the posted positions.

Job seekers typically do not pay to use online job boards. Consequently, hundreds, if not thousands of applicants may apply for a given position. In doing so, the job seeker blindly sends their resume without any notice their resume was received or viewed.

For above reasons and more, the process of using a traditional job board can be inefficient, costly, time consuming, and frustrating. Recognizing the challenges of the current job board industry, a new model for connecting job seekers and recruiters/employers may be desirable.

Published documents related to aspects of the present disclosure include U.S. Pat. Nos. 7,346,545; 7,505,919; 7,555,460; and 7,827,101; and U.S. Published Patent Application Nos. 2002/0072946 and 2002/0019738.

### SUMMARY OF EXAMPLE EMBODIMENTS

A token-based method of facilitating employment over a communications network is provided. The method includes providing at least one database of electronic data at a computer site. The data includes job description data that identifies job opportunities. The data further includes job provider data that identifies job providers associated with the job opportunities. The data still further includes cost data that identifies a cost to a job applicant to apply for each job associated with the job opportunities and for which payment in tokens is required. The data further includes job applicant data that identifies job applicants and profiles of the job applicants. The method further includes receiving digital tokens having a monetary or associated currency value from a job applicant and storing the received tokens in a token account of the job applicant. The method still further includes receiving a job application signal indicating that a job applicant desires to apply for a job associated with the job opportunities. The method further includes transferring at least one token from the token account of the job applicant to a token escrow account in response to the job application signal. The at least one token in the token escrow account is inaccessible to the job applicant. The monetary or associated currency value of the at least one token is based on the cost to apply for the desired job. The method still further includes retrieving and transmitting job applicant data of the job applicant who is applying for the desired job from the database to the job provider associated with the desired job. The method further includes debiting the at least one token identified with the job applicant applying for the desired job from the token escrow account when the transmitted job applicant data is received and viewed by the job provider associated with the desired job.

The method may further include automatically transferring the at least one token from the token escrow account to the token account for the job applicant after a predetermined period of time has elapsed after reception of the job application signal without the job provider associated with the desired job viewing the job applicant data.

The method may further include receiving a hiring signal from the job applicant. The hiring signal may indicate that the job applicant was hired by the job provider.

The method may further include receiving a confirmation signal from the job provider that the job applicant was actually hired.

The method may further include paying the job applicant a bonus having monetary or associated currency value in response to the confirmation signal.

The method may further include receiving a payment from the job provider when the job applicant is actually hired.

The tokens of the job applicant may be usable to pay for goods and services associated with employment.

The method may further include measuring use of the computer site and providing a corresponding measurement of the use.

The method may further include issuing digital tokens to job applicants who pay for the tokens.

The communications network may be a computer network.

The communications network may be the Internet.

The computer site may be a website.

The computer site may include a database server.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a flowchart diagram illustrating a method of providing an online employment service in accordance with an embodiment; and

FIG. 2 is a screen shot of a web site illustrating an inbox, recent matched jobs, and a jobs manager in accordance with an embodiment;

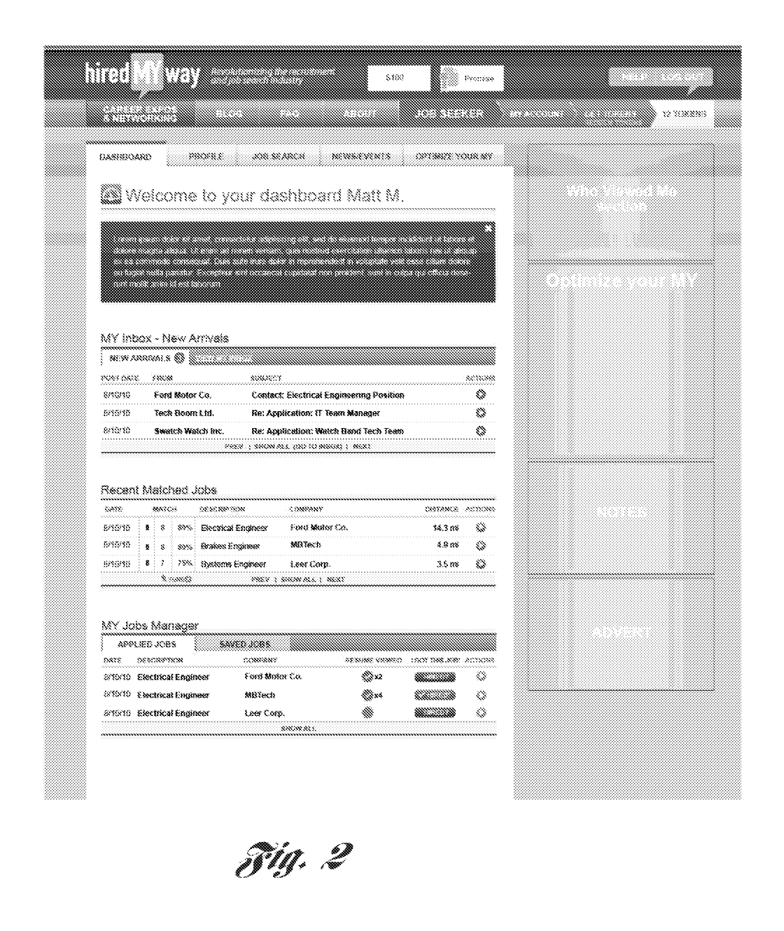

FIG. 3 is a screen shot of a web site illustrating a job description and a prompt option to apply to the job listing with an indications of the company, the position, and the cost associated with the job listing in accordance with an embodiment;

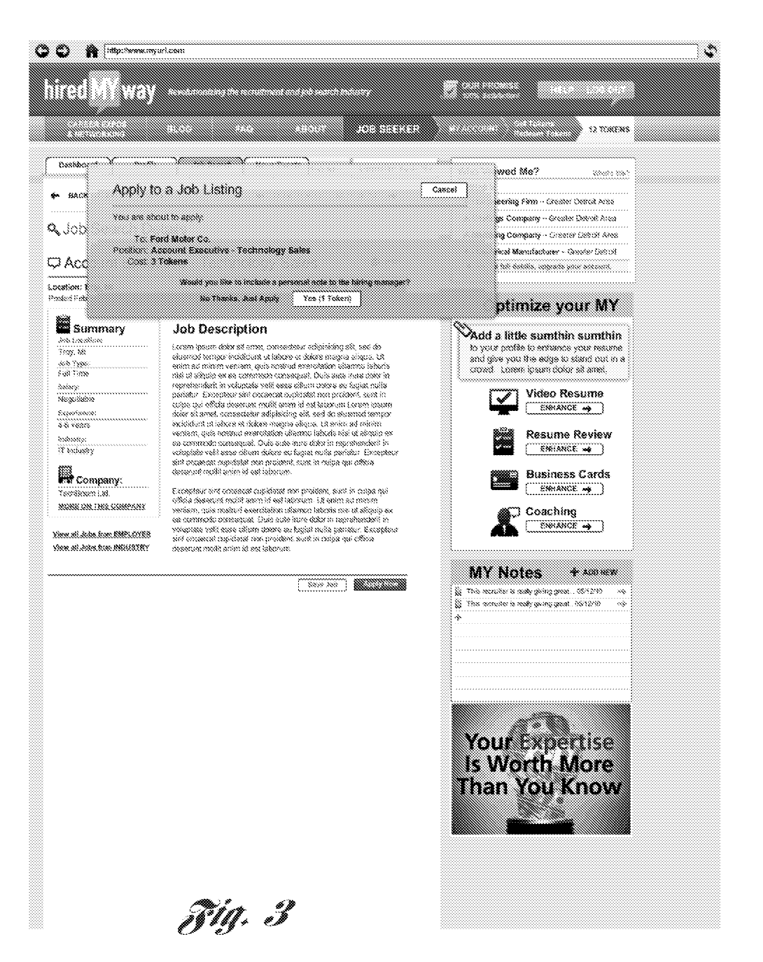

FIG. 4 is a screen shot of a web site illustrating a prompt option for a user to confirm that the user was hired for a job in accordance with an embodiment;

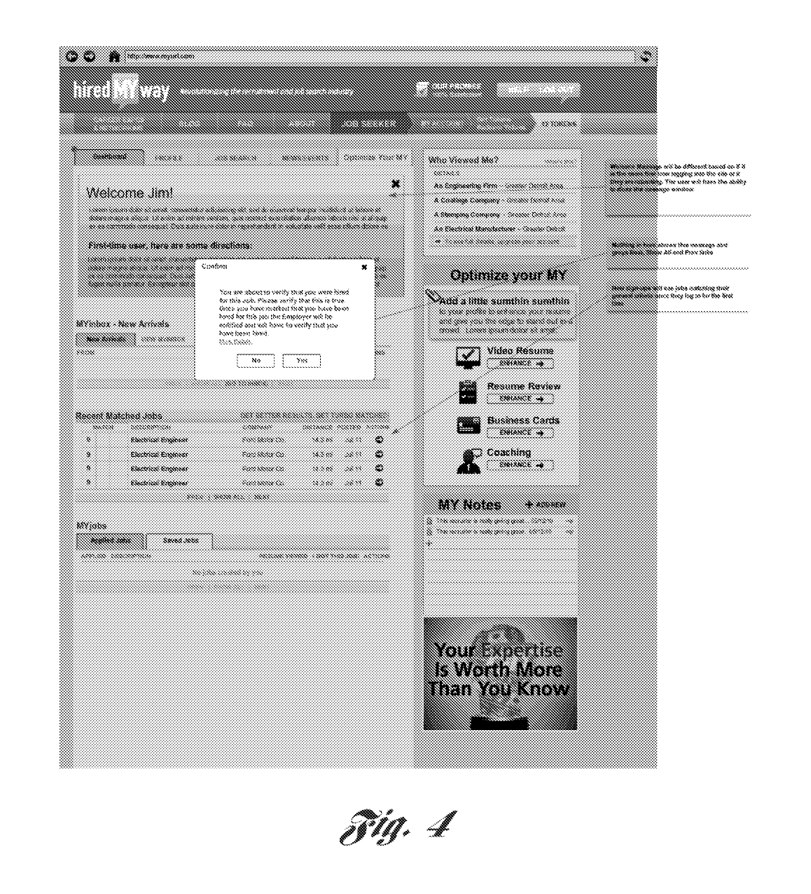

FIG. 5 is a screen shot of a web site illustrating a prompt option for an employer or recruiter to confirm that the user was hired for a job in accordance with an embodiment;

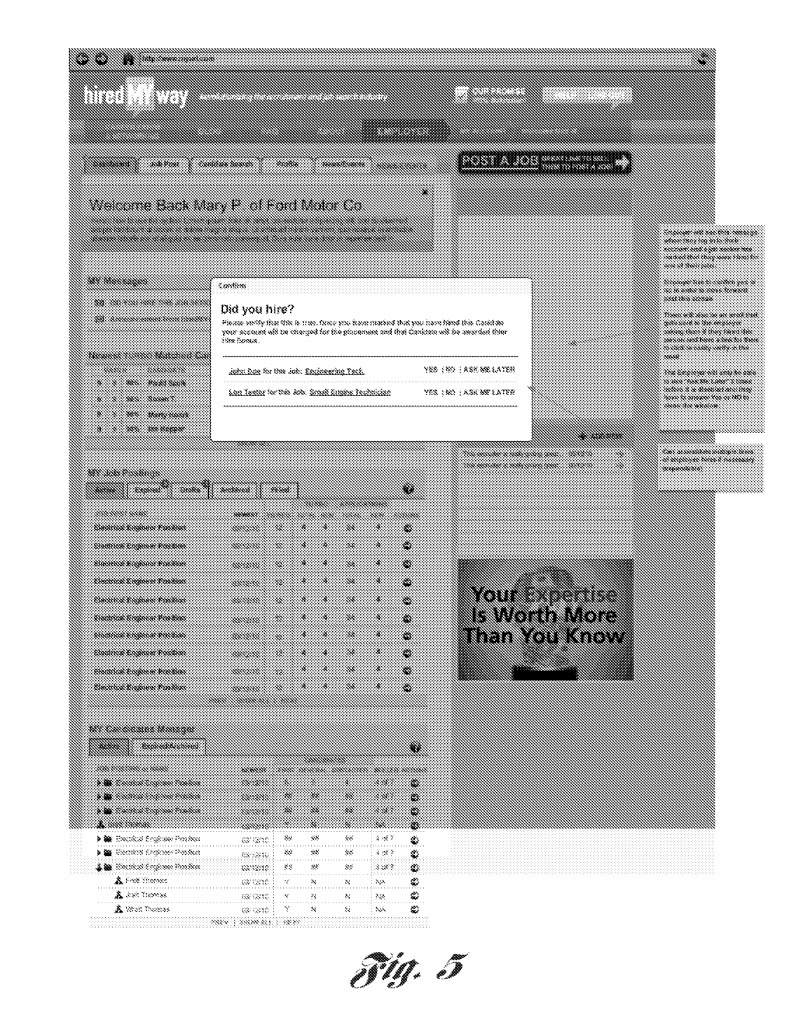

FIG. 6 is a screen shot of a web site illustrating an interface including an inbox, matched candidates, job postings, and candidates manager for the employer or recruiter in accordance with an embodiment; and

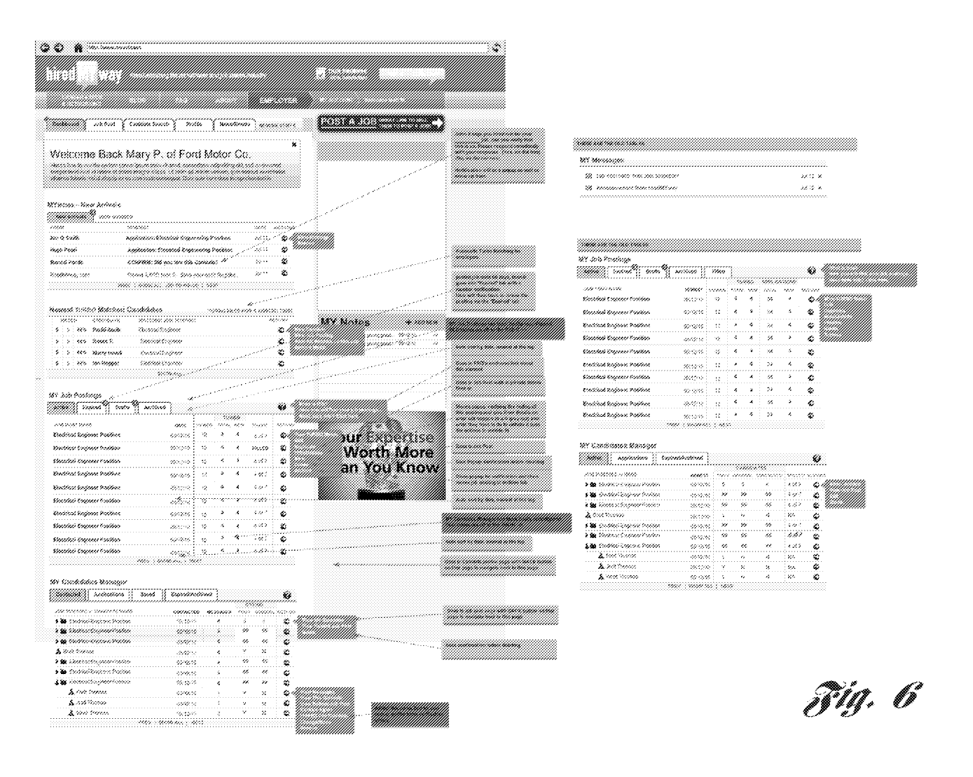

FIG. 7 is a block diagram of a computer system upon which embodiments of the invention may be implemented.

### DETAILED DESCRIPTION OF EXAMPLE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure provide a computerized method and system for providing an online employment service that recruits one or more job seekers and one or more recruiters and/or employers. The system and its method of operation are described in a general fashion to facilitate understanding of various aspects of the system and method. As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations.

One or more companies, employers, and/or recruiters can post an employment opportunity without an upfront cost. Posting the job is free. In addition to posting the employment opportunity, the one or more companies, employers, and/or recruiters may post other information about the job, such as where the job is located geographically and a description of the job. The company, employer, and/or recruiter only incurs a cost (e.g., $500) when it successfully hires a job seeker using the system and/or method.

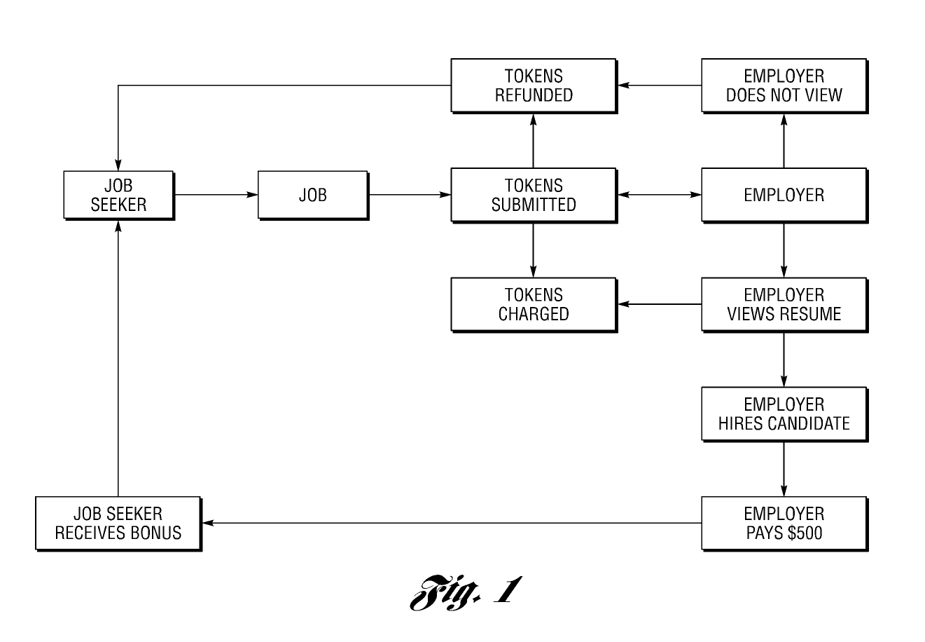

With reference to FIG. 1, a job seeker or candidate registers on the web site for free and pays for tokens. Tokens are nominally priced. The tokens have monetary value or an associated currency value (e.g., U.S. dollars). The job seeker uses the tokens to apply to one or more jobs or employment opportunities.

When a job seeker applies for a position, their tokens are stored in an escrow-type account (“Tokens Submitted”). The tokens in the escrow account are not accessible by the job seeker for further use. Furthermore, the tokens in the escrow account are not fully spent. The tokens associated with the job seeker can be charged to or debited from the job seeker's token account, such as when the job seeker's profile or resume is reviewed by a company, employer, and/or recruiter that posted the job that the job seeker applied to. This may occur when the company, employer, and/or recruiter opens the candidate's profile in their inbox. When company, employer, and/or recruiter reviews the job seeker's profile or resume, the tokens are removed from escrow and are deemed “spent” (“Tokens Charged”). The job seeker's profile may include information associated with the job seeker, such as the job seeker's resume, which the job seeker may post to be made accessible to companies, employers, and/or recruiters that post a job and that the applicant has applied to.

Tokens may be used to pay for other functionality or services. For example, the job seeker may use the tokens to submit their resume to a “filtered” pool of serious candidates. Furthermore, tokens may be used to purchase profile upgrades (video resumes/profiles, business cards, etc.) and other useful accessories and/or upgrades on the web site. Tokens can be used as an investment to improve the job seeker's potential success in finding a position.

Tokens may also be used as currency to apply for a high-demand time or V.I.P. time at a career exposition (“career expo”) and/or other goods and services offered at such a career expo. Tokens may also be used as payment to attend off-site seminars, provide video and portrait profiles, provide resume review, etc.

When applying for a job, the job seeker is only required to pay for the tokens if the job seeker's resume is actually viewed by a recruiter/employer, which can be monitored on the Job Seekers Jobdash™ or may be transported to a portable electronic device. The portable electronic device may be a mobile phone, smart phone, personal digital assistant (PDA), pager, laptop computer, or any other suitable electronic device that is portable and has a user interface, such as a graphical user interface (GUI). The portable electronic device facilitates wireless transmission of information from the system to the user. In addition, the portable electronic device facilitates wireless transmission from the user to the system. For example, the portable electronic device may access the Internet to send and receive information associated with the system and/or its associated features.

The portable electronic device may be reprogrammed with an application or program to provide the user interface that was previously not included in the device when the user first obtained the device. The user interface can be reconfigured in response to executing the application or program on the wireless device. Furthermore, the user, such as a job seeker, company, employer, and recruiter, may modify or customize the interface based on the job seeker's preferences or capabilities. For example, a job seeker may wish to modify the layout or format of its Jobdash™ Modifying or customizing the interface may require payment of a predetermined number of tokens from the user.

If the job seeker gets the job, then the applicant gets a bonus (e.g., $100). Thus, the job seeker may recoup the cost of applying for the job. The bonus can give the job seeker an incentive to look for a job that the job seeker believes to be qualified to undertake.

To attract job postings on the system, the company, employer, and/or recruiter can post positions for free and only pay when a candidate is actually hired. The candidate will receive a $100 signing bonus when the candidate reports being hired through the system, allowing the system to track the transaction and charge the employer.

If a predetermined number of time lapses, such as 15 days, and the profile of the job seeker is not opened by the employer, then the tokens are transferred from the escrow account back to the job seeker's account. Consequently, the tokens that were returned to the job seeker's account may be used to apply for additional jobs and/or service upgrades on the web site. For example, the job seeker may pay $10 to the web site host to apply for 5 jobs. If 3 employers view the resumes, then the job seeker is charged $6. Some jobs may cost more than other jobs (based on salary or other qualifiers t.b.d.). If the candidate is hired for the job, then the candidate can click an icon indicating that they were hired for the job. When the candidate clicks the icon indicating they were hired for the job, a message is sent to the employer asking the employer to verify that it has hired the candidate who clicked the icon.

The company who posted the job may determine or change the cost of applying to the job that the company posted. For example, the company may increase the cost of applying to the job if there are too many applicants or if the company only wants applicants who are serious about accepting an offer from the company (assuming only serious applicants would be willing to pay the higher cost and less serious applicants would be discouraged)

The system may also determine the amount of tokens required, including but not limited to, the salary of the position, type of position, full time, part time, contract, etc.

Companies and job seekers can pay a monthly fee to access a Turbo Filter system which will electronically allow employers/candidates to pair down matches based on criteria important to the company/job seeker.

For Recruiters/Employers

1. Recruiters/Employers post jobs at no charge through hiredMYway, only paying when they find the right candidate.

2. As a result of hiredMYway's innovative token system, recruiters/employers only receive resumes from serious candidates, streamlining the application process to ensure more effective and efficient hiring.

3. hiredMYway.com has a unique, optional Turbo Filter system. The system improves the chances of a successful match by asking candidates and recruiters/employers a series of specific questions that will pair job seekers with appropriate jobs based on the seekers' qualifications, experiences and related criteria and the recruiter's/employer's like job requirements.

4. Recruiters/employers can further qualify job seekers by submitting job/company specific questions to the final job seeker candidate pool.

This frees up time and resources for recruiters/employers by eliminating the need to sift through hundreds, if not thousands, of applications from unqualified applicants.

5. Recruiters/Employers can track the progress of their candidate search through their personal website dashboard (Jobdash™) where they can monitor posted positions and applicants, as well as blog and Twitter feeds related to their company and job postings.

6. Through hiredMYway career expos, recruiters/employers have access to a number of job seekers. Job seekers who feel qualified for a job, may sign up for V.I.P. interviews (limited to (10) per recruiter) for a nominal charge preceeding the “open” Expo which is free to all candidates. Recruiters/employers will also have the option of selecting promising candidates during the Career Expo that specifically meet their job criteria for 15 minute one-on-one on-site interviews.

### For Job Seekers

1. Candidates who get a job through hiredMYway receive a signing bonus (e.g. $100.00), which allows the website to track and quantify successful matches.

2. Through hiredMYway's token system, applicants invest a nominal fee to apply for a job, increasing their chances of having their resume reviewed. Unqualified or disinterested candidates are less likely to invest in the same jobs, resulting in a smaller applicant pool.

3. Job seekers also have the optional ability to use the Turbo Filter system to improve the chances of a successful job match.

4. Job seekers can track the progress of their job search through their personal web site dashboard (Jobdash™) where they can monitor, blog, and enhance their profiles.

5. hiredMYway provides jobs seekers the tools they need to differentiate themselves from other potential hires by giving them access to but not limited to professional resume writers, recruitment experts, and career coaches both online and at the career expos. Job seekers also have the ability to create and upload video resumes/profiles and/or portraits to the web site.

6. hiredMYway hosts ongoing career expos giving job seekers access to companies that are hiring and thousands of jobs. Candidates can have optional V.I.P. time with recruiters/employers and may also be selected for personal one-on-one interviews at the expo.

### Hardware Overview

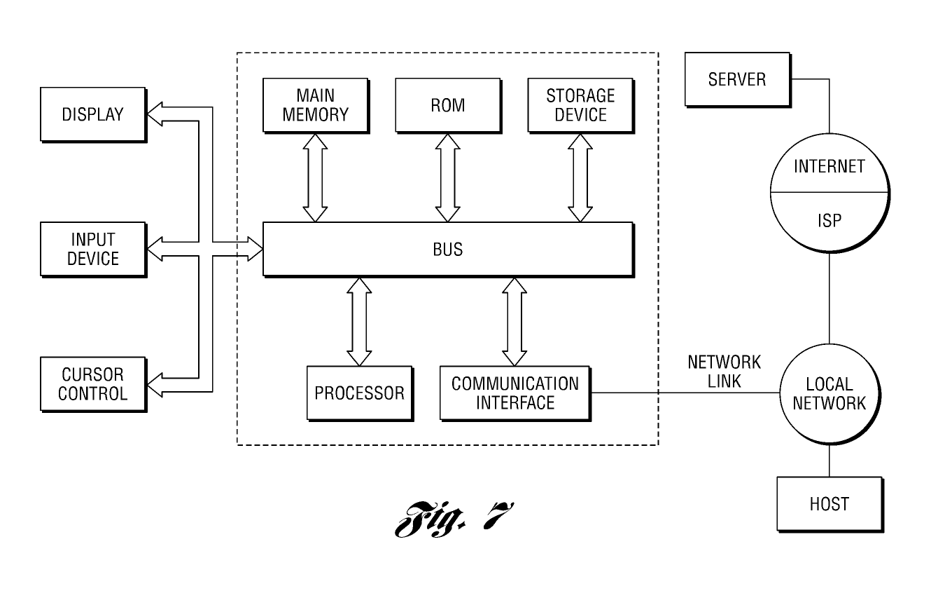

With reference to FIG. 7, a block diagram is provided to illustrate a computer system upon which an embodiment of invention may be implemented. The computer system includes a bus or other communication mechanism for communicating information, and a processor coupled with bus for processing information. The computer system also includes a main memory, such as a random access memory (RAM) or other dynamic storage device, coupled to bus for storing information and instructions to be executed by processor. Main memory also may be used for storing temporary variables or other intermediate information during execution of instructions to be executed by processor. The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as a cathode ray tube (CRT), for displaying information to a computer user. An input device, including alphanumeric and other keys, is coupled to the bus for communicating information and command selections to processor. Another type of user input device is cursor control, such as a mouse, a trackball, or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

At least one embodiment of invention is related to the use of a computer system for implementing the techniques described herein. According to one embodiment of the invention, those techniques are performed by the computer system in response to a processor executing one or more sequences of one or more instructions contained in main memory. Such instructions may be read into main memory from another computer-readable medium, such as a storage device. Execution of the sequences of instructions contained in main memory causes the processor to perform the process steps described herein. In alternative embodiments, hard-wired circuitry may be used in place of or in combination with software instructions to implement the system and/or method. Thus, embodiments of the invention are not limited to any specific combination of hardware circuitry and software.

The term “computer-readable medium” as used herein refers to any medium that participates in providing data that causes a machine to operate in a specific fashion. In an embodiment implemented using the computer system, various computer-readable media are involved, for example, in providing instructions to the processor for execution. Such a medium may take many forms, including but not limited to storage media and transmission media. Storage media includes both non-volatile media and volatile media. Non-volatile media includes, for example, optical or magnetic disks. Volatile media includes dynamic memory, such as main memory. Transmission media includes coaxial cables, copper wire and fiber optics, including the wires that comprise a bus. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector can receive the data carried in the infra-red signal and appropriate circuitry can place the data on the bus. The bus carries the data to main memory, from which processor retrieves and executes the instructions. The instructions received by main memory may optionally be stored on the storage device either before or after execution by the processor.

The computer system also typically includes a communication interface coupled to bus. The communication interface provides a two-way data communication coupling to a network link that is connected to a local network. For example, communication interface may be an integrated services digital network (ISDN) card or a modem to provide a data communication connection to a corresponding type of telephone line. As another example, communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

A network link typically provides data communication through one or more networks to other data devices. For example, the network link may provide a connection through local network to a host computer or to data equipment operated by an Internet Service Provider (ISP). The ISP in turn provides data communication services through the world wide packet data communication network now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

Computer system can send messages and receive data, including program code, through the network(s), the network link and the communication interface. In the Internet example, a server might transmit a requested code for an application program through the Internet, ISP, local network and communication interface.

The received code may be executed by processor as it is received, and/or stored in storage device, or other non-volatile storage for later execution. In this manner, the computer system may obtain application code in the form of a carrier wave.

HiredMYway web site
hiredMYway can provide the human element to the often frustrating job search, regularly hosting career expos where candidates have the chance for 15 minute one-on-one interviews with potential employers. The career expo also provides an optional one hour V.I.P. session where the job seeker is guaranteed 5 minutes of personal time with the recruiter/employer of their choice.
hiredMYway may provide upgrades and enhancements to the job seeker online, at the Expos and sponsored hiredMYway events. Those upgrades include but are not limited to help seminars, video resumes/profiles, portraits, business cards, resume services, networking parties, etc.
hiredMYway can put people back to work by effectively and efficiently pairing candidate profiles to job descriptions, enhancing a successful match.
hiredMYway can improve the hiring process for all involved through innovative tools and resources for both job seekers and recruiters/employers such as filtering job seekers, matching resumes, and personalizing recruiter/employer resume review.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A token-based method of facilitating employment over a communications network, the method comprising:
providing at least one database of electronic data at a computer site, the data including:
job description data that identifies job opportunities;
job provider data that identifies job providers associated with the job opportunities;
cost data that identifies a cost to a job applicant to apply for each job associated with the job opportunities and for which payment in tokens is required; and
job applicant data that identifies job applicants and profiles of the job applicants;
receiving digital tokens having a monetary or associated currency value from a job applicant and storing the received tokens in a token account of the job applicant;
receiving a job application signal indicating that a job applicant desires to apply for a job associated with the job opportunities;
transferring at least one token from the token account of the job applicant to a token escrow account in response to the job application signal, wherein the at least one token in the token escrow account is inaccessible to the job applicant, and wherein the monetary or associated currency value of the at least one token is based on the cost to apply for the desired job;
retrieving and transmitting job applicant data of the job applicant who is applying for the desired job from the database to the job provider associated with the desired job; and
debiting the at least one token identified with the job applicant applying for the desired job from the token escrow account when the transmitted job applicant data is received and viewed by the job provider associated with the desired job.

2. The method as claimed in claim 1 further comprising automatically transferring the at least one token from the token escrow account to the token account for the job applicant after a predetermined period of time has elapsed after reception of the job application signal without the job provider associated with the desired job viewing the job applicant data.

3. The method as claimed in claim 1 further comprising receiving a hiring signal from the job applicant, the hiring signal indicating that the job applicant was hired by the job provider.

4. The method as claimed in claim 3 further comprising receiving a confirmation signal from the job provider that the job applicant was actually hired.

5. The method as claimed in claim 4 further comprising paying the job applicant a bonus having monetary or associated currency value in response to the confirmation signal.

6. The method as claimed 1 further comprising receiving a payment from the job provider when the job applicant is actually hired.

7. The method as claimed in claim 1 wherein the tokens of the job applicant are usable to pay for goods and services associated with employment.

8. The method as claimed in claim 1 further comprising measuring use of the computer site and providing a corresponding measurement of the use.

9. The method as claimed in claim 1 further comprising issuing digital tokens to job applicants who pay for the tokens.

10. The method as claimed in claim 1 wherein the communications network is a computer network.

11. The method as claimed in claim 1 wherein the communications network is the Internet.

12. The method as claimed in claim 1 wherein the computer site is a website.

13. The method as claimed in claim 1 wherein the computer site comprises a database server.
